(19) United States
(12) Patent Application Publication
(10) Pub. No.: US 2025/0264603 A1
(43) Pub. Date: Aug. 21, 2025

(54) METHOD FOR MONITORING THE DEFORMATION BY COMBINED USE OF LIDAR AND RADAR MEASUREMENTS

(71) Applicant: IDS GEORADAR S.R.L., Milano (IT)

(72) Inventors: Alberto BICCI, Empoli (IT); Claudio TESTA, Massa (IT); Matteo CECCHETTI, Pisa (IT); Martina ROSSI, Pontedera (IT); Francesco COPPI, Calcinaia (IT); Reto STUTZ, Au (CH)

(73) Assignee: IDS GEORADAR S.R.L., Milano (IT)

(21) Appl. No.: 18/855,185

(22) PCT Filed: Apr. 7, 2023
(86) PCT No.: PCT/IB2023/053578

§ 371 Date: Oct. 8, 2024

(30) Foreign Application Priority Data
Apr. 8, 2022 (IT) 102022000007091

(51) Int. Cl. G01S 13/90; G01S 13/86

(52) U.S. Cl. CPC G01S 13/9023; G01S 13/865; G01S 13/867

(57) ABSTRACT

A method for monitoring the deformation of a scenario comprising a first step of prearranging a device (100) for monitoring the deformation of a scenario comprising a support (105), a LIDAR sensor (110), a radar sensor (120), at least one actuator arranged to move the LIDAR sensor (110) and the radar sensor (120) with respect to the support (105). The method then comprises the steps of defining a spatial reference system S comprising a rotation axis z, integral with the support (105), rotating the LIDAR sensor (110) about its rotation axis z, and contemporaneous laser scanning of the scenario, obtaining a three-dimensional model comprising a plurality of points Pₗ of the scenario. The method also comprises the steps of rotating the radar sensor (120) about its rotation axis z, and contemporaneous radar scanning of said scenario, obtaining at least two matrices of complex data comprising information of amplitude and phase of a plurality of points Pᵣ. The method also comprises the steps of focusing the at least two matrices of complex data obtaining at least two focused images of the scenario, comparing the at least two focused images of the scenario obtaining a relative interferogram and generating a three-dimensional map of the scenario superimposing the relative interferogram with the three-dimensional model in such a way that points Pₗ and Pᵣ having the same spatial coordinates with respect to the spatial reference system S are superimposed to each other.

### FIELD OF THE INVENTION

The present invention relates to the field of structural monitoring by means of SAR (Synthetic apertures Radar) interferometry.

In particular, the invention relates to a method for monitoring the deformation of a scenario integrates SAR interferometry technology with laser which scanning technology using a LIDAR sensor.

### DESCRIPTION OF THE PRIOR ART

As known, in order to monitor the stability of structures such as houses, bridges or structures of historical-cultural interest, monitoring devices based on laser technology are currently used. The purpose of these monitoring systems is to provide information relating to the deformations of the structure, taking the appropriate measures in the event of detection of anomalous movements (evacuation of buildings, structural rehabilitation interventions).

In the majority of cases, these laser systems require the installation of optical reflectors which are fixed in correspondence with the areas to be monitored, measuring their position at regular intervals so as to detect any movement with an accuracy of about 1 mm.

The installation of reflectors on such structures is sometimes not easy, above all if one operates in historic centers or on buildings of particular cultural value, or if the structures are not easily accessible and the installation of the reflectors becomes operationally very onerous (for example on very tall buildings).

Other techniques are based on contact measurement systems using, for example, crack gauges or strain gauges, which however pose the same problems related to direct access to the surface to be monitored, as well as making it necessary to purchase a large number of sensors if the area to be monitored is very large.

An alternative solution is the use of an interferometric radar, a technology widely used for the critical monitoring of landslides in a mining context. Radar interferometry provides displacement measurements with sub-millimeter accuracy and is therefore more effective in detecting the deformation of the structure of interest. At the same time, this technology can operate without the need to install reflectors on the scenery, exploiting only the natural reflectivity of the monitored surfaces.

However, this technology suffers from some well-known limitations. In particular, an interferometric radar is subject to phase ambiguity phenomena for which it is impossible to measure displacements greater than a quarter of the wavelength and is also capable of measuring only the projection of the scenario displacement along the line of sight of radar (LOS, Line of Sight).

To overcome these limitations, a method of integrating the radar interferometric technique with laser-based strain measurement is proposed by the document “Integration of radar interferometry and laser scanning for remote monitoring an urban site built on slidingly slope.”, Pieraccini Masthe likeano et al., IEEE Trloopctions on geoscience and remote sensing 44.9 (2006): 2335-2342. In this document, both techniques compare images taken at different times, to map and classify the changes that have occurred in the scenario. Radar and laser data are collected on the same dates with a time separation of approximately ten months.

However, in the method proposed by this document, since the scanning systems are independent devices, to combine the data it is mathematically necessary to measure the position of each system in 3D space and the directions of the viewing angles for each measurement session. This involves both a high operational complexity and systematic errors in the union of radar and laser data due to misalignment in the identification of the coordinates of the characteristic points of the scenario.

Furthermore, the two systems do not cover the same areas and the coverage overlap is only partial. Therefore, since the viewpoints of SAR and laser are different and the observed areas are accordingly different, monitoring can only be done for areas where both radar and laser information are available.

### SUMMARY OF THE INVENTION

It is therefore a feature of the present invention to provide a method for monitoring the deformation of a scenario which allows to automatically combine the data obtained by means of radar and laser technologies, without the need to measure the positions of the sensors or the direction of the angle of vision.

It is also a feature of the present invention to provide such a method which allows a greater superimposition of the data, in terms of areas covered, than in the prior art.

It is also a feature of the present invention to provide such a method which allows to overcome the limitations due to the interferometric phase ambiguity and the uncertainty of the displacement direction.

It is a further feature of the present invention to provide a device which implements this method for monitoring the deformation of a scenario.

These and other objects are achieved by a method for monitoring the deformation of a scenario comprising the steps of:
prearranging a device for monitoring the deformation of a scenario comprising:
   a support;
   a LIDAR sensor;
   a radar sensor;
   at least one actuator arranged to move said LIDAR sensor and said radar sensor with respect to said support;
defining a spatial reference system S comprising a rotation axis z, said spatial reference system S being integral with said support;
rotating said LIDAR sensor about said rotation axis z, by means of said or each actuator;
during said step of rotating said LIDAR sensor, laser scanning of said scenario, obtaining a three-dimensional model comprising a plurality of points Pₗ of said scenario, for each point Pₗ of said scenario being known the spatial coordinates with respect to said spatial reference system S;
rotating said radar sensor about said rotation axis z, by means of said or each actuator;
during said step of rotating said radar sensor, radar scanning of said scenario, obtaining at least two matrices of complex data comprising information of amplitude and phase of a plurality of points Pᵣ of said scenario, for each point Pᵣ of said scenario being known the spatial coordinates with respect to said spatial reference system S;
focusing said at least two matrices of complex data obtaining at least two focused images of said scenario;
comparing said at least two focused images of said scenario obtaining an relative interferogram;
generating a three-dimensional map of said scenario superimposing said relative interferogram with said three-dimensional model in such a way that points Pₗ and Pᵣ having the same spatial coordinates with respect to said spatial reference system S are superimposed to each other.

Since the radar sensor and the LIDAR sensor are arranged on the same device and are moved with respect to the same support, the radar and laser scans produce data relating to the same reference system S. In this way, the present invention allows greater precision in the definition of the coordinates of characteristic points and less computational time for overlaying radar and laser data.

In particular, said radar sensor is arranged to perform a scanning by means of SAR technology.

Advantageously, said step of rotating said LIDAR sensor and said step of rotating said radar sensor take place simultaneously.

Therefore, said step of laser scanning and said step of radar scanning of said scenario take place simultaneously.

This way, the acquisition times of the data relating to the scenario are optimized.

In particular, a step is also provided of rotating said LIDAR sensor about a rotation axis x, orthogonal to said rotation axis z, by means of said or each actuator. Advantageously, said step of rotating said LIDAR sensor about said rotation axis x is carried out simultaneously with said step of rotating said LIDAR sensor about said rotation axis z.

In this way, it is possible to carry out the laser scanning at different elevation angles and it is not necessary, as in the prior art, to carry out a multiplicity of acquisitions at different “tilt” angles, or baselines, but it is possible to obtain the three-dimensional model of the scenario with a single rotation around the z axis and acquisition.

Alternatively, said LIDAR sensor is arranged to simultaneously emit a plurality of laser beams at different elevation angles. In particular, said LIDAR sensor is a “multi-beam” type laser.

In this way, it is possible to perform laser scanning at different elevation angles, without having to rotate the LIDAR sensor around the rotation axis x. This has the advantage of a higher overall speed of the scenario scan.

Advantageously, the present invention provides that the rotation of the radar sensor around the rotation axis z and the rotation of the LIDAR sensor around the rotation axis z and around the rotation axis x take place simultaneously. Consequently, the radar scan and the laser scan at different elevation angles take place simultaneously by performing, in a single rotation and acquisition, the complete three-dimensional scan of the scenario.

Therefore, the present invention provides that the radar scan and the laser scan are performed simultaneously, during a single rotation around the rotation axis z, and by acquiring the laser data of multiple baselines of the scenario. In a first embodiment, this acquisition at different baselines is performed by rotating the LIDAR sensor around the rotation axis x simultaneously with the rotation of the same LIDAR sensor around the rotation axis z. In a second embodiment, this acquisition at different baselines is instead performed thanks to the use of a “multi-beam” type LIDAR sensor, i.e. capable of projecting different laser beams at different elevation angles of the scenario. In both cases, it is possible to obtain the three-dimensional model of the scenario with a single rotation around the rotation axis z, during which both the laser scan and the radar scan take place. In this way, it is not necessary, as in the prior art, to carry out a multiplicity of acquisitions at different “tilt” angles, or baselines.

In particular, said device also comprises a camera and a step is also provided of acquiring photographic images of said scenario.

Advantageously, a step is also provided of overlapping at least one of said photographic images with said three-dimensional model acquired by means of laser scanning.

In this way, it is possible to add a photographic texture which makes the visualization of the scenario more intuitive.

In particular, a step is also provided of generating a three-dimensional mesh starting from said three-dimensional model, said three-dimensional mesh comprising a plurality of faces arranged to define the shape of a polyhedral object of said scenario.

The three-dimensional mesh allows a three-dimensional view of the scenario, making it even more intuitive and accurate.

Advantageously, in the case of creating a three-dimensional mesh, the step of superimposing the photographic images provides that each face of the three-dimensional mesh is associated with a corresponding photographic image.

In a step particular, is also provided of calculating at least one three-dimensional vector of displacement \vec{d} of the points of said scenario, said step of calculating comprising the steps of:
making at least two radar scans at a time interval Δtᵣ;
calculating a displacement value d_{LOS} representing the component along the line of sight of the displacement of a point Pᵣ between said two radar scans in said time interval Δtᵣ;
making at least two laser scans at a time interval Δtₗ;
calculating the vector of the displacement direction \vec{d}ₗₐₛₑᵣ of a point Pₗ having same spatial coordinates of said point Pᵣ, between said two laser scans in said time interval Δtₗ, said vector of the displacement direction \vec{d}ₗₐₛₑᵣ having versor of displacement \vec{d}ₗₐₛₑᵣ and module dₗₐₛₑᵣ;
calculating the angle θ between said displacement direction calculated and said line of sight;
calculating the three-dimensional vector of displacement according to the equation \vec{d}=(d_{LOS}/cos θ)\hat{d}ₗₐₛₑᵣ.

The three-dimensional vector of displacement \vec{d} provides complete information about the entity of the movements of the characteristic points of the scenario.

Advantageously, a step is also provided of graphic superimposition of said or each vector of displacement \vec{d} to said three-dimensional map of said scenario.

In particular, a discontinuous monitoring procedure is also provided comprising the steps of:
arranging said device at a monitoring point;
making said step of laser scanning of said scenario at instant t₁, obtaining a three-dimensional model comprising a plurality of points Pₗ, each point Pₗ having spatial coordinates Cₗ(t₁);
making said step of radar scanning of said scenario at instant t₁, obtaining at least one matrix of complex data comprising information of amplitude and phase of a plurality of points Pᵣ, each point Pᵣ having spatial coordinates Cᵣ(t₁);
removing said device from said monitoring point;
rearranging said device in said monitoring point, resulting in a translation repositioning error Δrₚₒₛ≥0 and a rotation repositioning error Δφₚₒₛ≥0;
making said step of laser scanning of said scenario at instant t₂, obtaining a three-dimensional model comprising a plurality of points Pₗ, each point Pᵣ having spatial coordinates Cₗ(t₂);
making said step of radar scanning of said scenario at instant t₂, obtaining at least one matrix of complex data comprising information of amplitude and phase of a plurality of points Pᵣ, each point Pᵣ having spatial coordinates Cᵣ(t₂);
comparing said coordinates Cₗ(t₁) and Cₗ(t₂) of said points Pₗ obtaining said repositioning errors Δrₚₒₛ and Δφₚₒₛ;
calculating the relative interferogram comparing said matrix of complex data relative to the instant t₁ and said matrix of complex data relative to the instant t₂, taking into account said repositioning errors Δrₚₒₛ and Δφₚₒₛ.

The discontinuous monitoring procedure allows scenario monitoring to be put on standby and then resumed without producing misalignment errors.

Advantageously, in the case of the condition d_{LOS(laser)}>λ/4, where d_{LOS(laser)}=dₗₐₛₑᵣ*cos θ and λ is the wavelength of said radar sensor, a step is provided of disambiguating the radar measurement wherein said displacement value d_{LOS} is replaced by a modified displacement value

$${{d}_{LOS}}^{′} = {d}_{LOS} + \frac{λ}{2} {k}_{laser ′} {k}_{laser} = - floor [ \frac{- 2 {d}_{LOS ( laser )}}{λ} + \frac{1}{2} ] .$$

The disambiguation phase of the radar measurement makes it possible to solve the problem whereby the radar is unable to measure movements beyond a certain threshold.

In particular, in case that, following said laser scanning of said scenario, there is ambiguity in the calculating a spatial coordinate Rₗ of a point Pₗ, obtaining possible spatial coordinates Rₗ₍ᵢ₎, with i=1, 2, . . . , n, a step is provided of disambiguating the laser measurement, wherein it is identified the spatial coordinate Rᵣ of a point Pᵣ obtained by means of radar scanning and having spatial coordinates, except Rᵣ, closest to the coordinates of Pₗ, in order to select the coordinate closest to Rᵣ among said possible spatial coordinates Rₗ₍ᵢ₎.

According to another aspect of the invention, a device for monitoring the deformation of a scenario is claimed comprising:
a support;
a LIDAR sensor;
a radar sensor;
at least one actuator arranged to move said LIDAR sensor and said radar sensor with respect to said support;

said device also comprising a control unit arranged to:
defining a spatial reference system S comprising a rotation axis z, said spatial reference system S being integral with said support;
operating a rotation of said LIDAR sensor about said rotation axis z, by means of said or each actuator;
during said step of rotating said LIDAR sensor, operating a laser scanning of said scenario, obtaining a three-dimensional model comprising a plurality of points Pₗ of said scenario, for each point Pₗ of said scenario being known the spatial coordinates with respect to said spatial reference system S;
operating a rotation of said radar sensor about said rotation axis z, by means of said or each actuator;
during said step of rotating said radar sensor, operating a radar scanning of said scenario, obtaining at least two matrices of complex data comprising information of amplitude and phase of a plurality of points Pᵣ of said scenario, for each point Pᵣ of said scenario being known the spatial coordinates with respect to said spatial reference system S;
carrying out a focusing of said at least two matrices of complex data obtaining at least two focused images of said scenario;
carrying out a comparison of said at least two focused images of said scenario obtaining a relative interferogram;
generating a three-dimensional map of said scenario superimposing said relative interferogram with said three-dimensional model in such a way that points Pₗ and Pᵣ having the same spatial coordinates with respect to said spatial reference system S are superimposed to each other.

In particular, at least one actuator is provided for moving said LIDAR sensor around a rotation axis x, orthogonal to said rotation axis z.

Alternatively, said LIDAR sensor is arranged to simultaneously emit a plurality of laser beams at different elevation angles.

### BRIEF DESCRIPTION OF THE DRAWINGS

The invention will be now shown with the following description of some embodiments, exemplifying but not limitative, with reference to the attached drawings in which:

FIG. 1 shows a possible embodiment of the device for monitoring the deformation of a scenario, according to the present invention;

FIG. 2 diagrammatically shows the possible steps of the method for monitoring the deformation of a scenario, according to the present invention;

FIG. 2A diagrammatically shows the calculation of the value d_{LOS} by means of radar scanning;

FIG. 2B diagrammatically shows the calculation of the versor of displacement \hat{d}ₗₐₛₑᵣ by means of laser scanning;

FIG. 4 diagrammatically shows a possible discontinuous monitoring procedure according to the present invention.

### DESCRIPTION OF SOME PREFERRED EMBODIMENTS

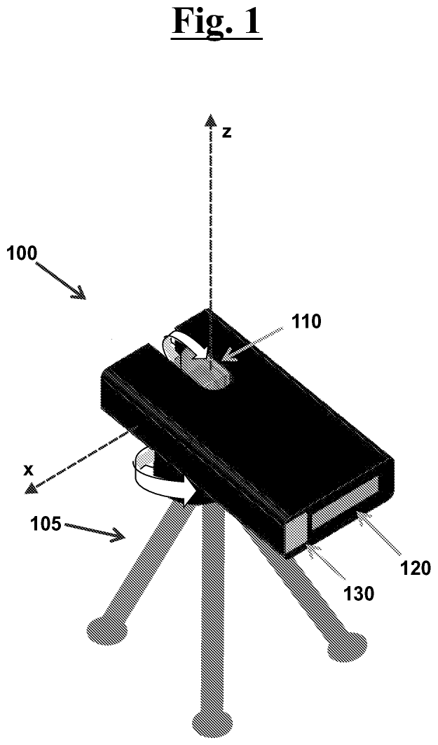

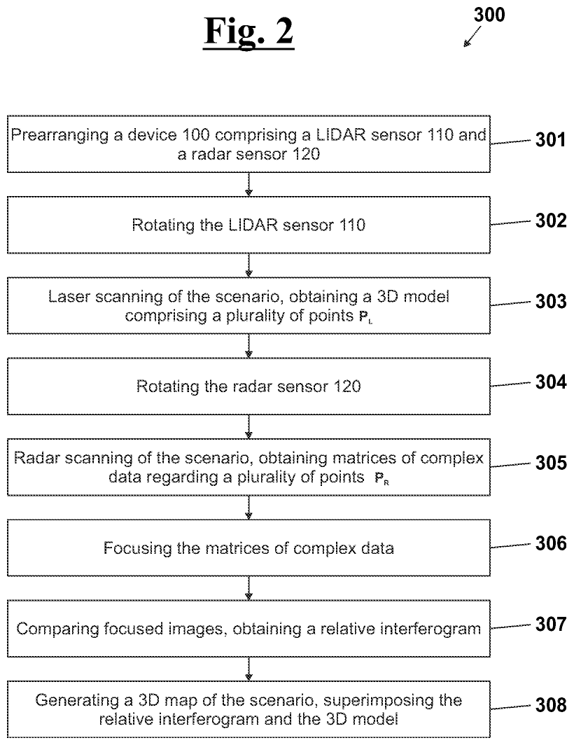

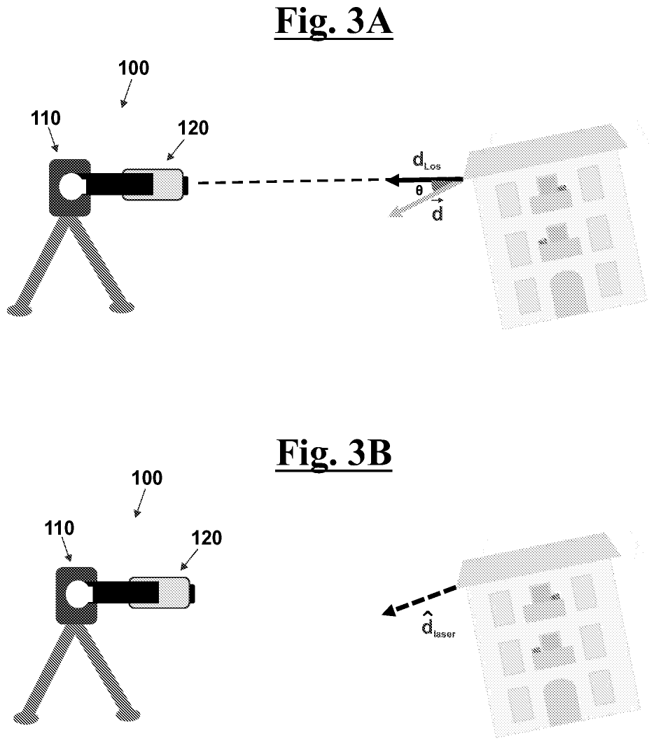

With reference to FIGS. 1 and 2, the method for monitoring the deformation of a scenario, according to the present invention, provides a first step of prearranging a device (100) comprising a support 105, a LIDAR sensor 110, a radar sensor 120 and at least one actuator, not shown for simplicity, suitable for moving the LIDAR sensor 110 and the radar sensor 120 with respect to a spatial reference system S integral with the support 105 and comprising a rotation axis z.

In particular, the actuator allows the simultaneous rotation of the LIDAR sensor 110 and of the radar sensor 120 around its axis z. Furthermore, in the embodiment of FIG. 1, the actuator allows the rotation of the LIDAR sensor 110 with respect to a rotation axis x, orthogonal to the rotation axis z, so as to carry out a suitable inclination of the LIDAR sensor 110 during the laser scanning.

In particular, thanks to the rotation of the LIDAR 110 sensor with respect to the rotation axis x and, simultaneously, around the rotation axis z, it is possible to perform 3D laser scanning at different elevation angles. In this way, it is not necessary, as in the prior art, to carry out a multiplicity of acquisitions at different “tilt” angles, or baselines, but it is possible to obtain the three-dimensional model of the scenario with a single rotation around the rotation axis z and relative acquisition of the radar data and laser data. With different “tilt” angles is intended “tilt” angles of the complete system composed of radar sensor and LIDAR sensor.

Alternatively, to obtain the same technical effect, a variant embodiment of the invention provides that the LIDAR sensor 110 is of the “multi-beam” type, i.e. capable of generating a multiplicity of laser beams, so as to simultaneously scan the scenario at different elevation angles thus avoiding the need to perform a mechanical tilting.

The method then provides the the simultaneous realization of a step of rotating the LIDAR sensor 110 about its axis z [303] and of a step of laser scanning of the scenario [303]. This way, it is possible to obtain a three-dimensional model of the scenario comprising a plurality of points Pₗ, in order to calculate, for each point Pₗ, the spatial coordinates with respect to the spatial reference system S.

The method also provides the simultaneous realization of a step of rotating the radar sensor 120 about its axis z [304] and of a step of radar scanning of the scenario [305]. This way, it is possible to obtain at least two matrices of complex data comprising information of amplitude and phase of a plurality of points Pᵣ of the scenario.

The steps of rotating the LIDAR sensor 110, with relative laser scanning, and the step of rotating the radar sensor 120, with relative radar scanning, can take place simultaneously or successively with respect to each other.

The method then provides a step of focusing the matrices acquired during the radar scanning, allowing to obtain at least two relative focused images of the scenario [306]. These focused images are then compared, obtaining a relative interferogram of the scenario.

The method finally provides a step of generating a three-dimensional map of the scenario by superimposing the relative interferogram with the three-dimensional model in such a way that points Pₗ and Pᵣ having the same spatial coordinates with respect to the spatial reference system S are superimposed to each other.

With reference to FIGS. 3A and 3B, in a possible embodiment of the method according to the present invention, a step is also provided of calculating at least one three-dimensional vector of displacement \vec{d} of the points of the scenario.

In particular, this step provides the realization of at least two radar scans at a time interval Δtᵣ and the calculation of a displacement value d_{LOS} representing the component along the line of sight of the displacement of a point Pᵣ between the two radar scans with time interval Δtᵣ.

Furthermore, this step provides the realization of two laser scans at a time interval Δtₗ and the calculation of the vector of the displacement direction \vec{d}ₗₐₛₑᵣ of a point Pₗ having same spatial coordinates of the point Pᵣ, between the two laser scans with time interval Δtₗ. In particular, the vector of the displacement direction \vec{d}ₗₐₛₑᵣ has versor of displacement \vec{d}ₗₐₛₑᵣ and module dₗₐₛₑᵣ.

More in particular, a first laser scanning is performed at an instant tₗ₁ and a second laser scanning is performed at an instant tₗ₂=tₗ₁+Δtₗ, creating two three-dimensional models of the scenario (pointcloud) relating, respectively, to the instant tₗ₁ and to the instant tₗ₂. Each three-dimensional model is subdivided into volume elements (voxel), each volume element having a respective point Pₗ as its geometric center. By applying co-registration algorithms to the volume elements which, in the two three-dimensional models acquired at instants tₗ₁ and tₗ₂, have a same point Pₗ as their geometric center, it is possible to calculate the vector of the displacement direction \vec{d}ₗₐₛₑᵣ of this point Pₗ.

This way, it is possible to calculate the angle θ between the calculated displacement direction and the line of sight and, therefore, the three-dimensional vector of displacement according to the equation \vec{d}=(d_{LOS}/cos θ) \hat{d}ₗₐₛₑᵣ.

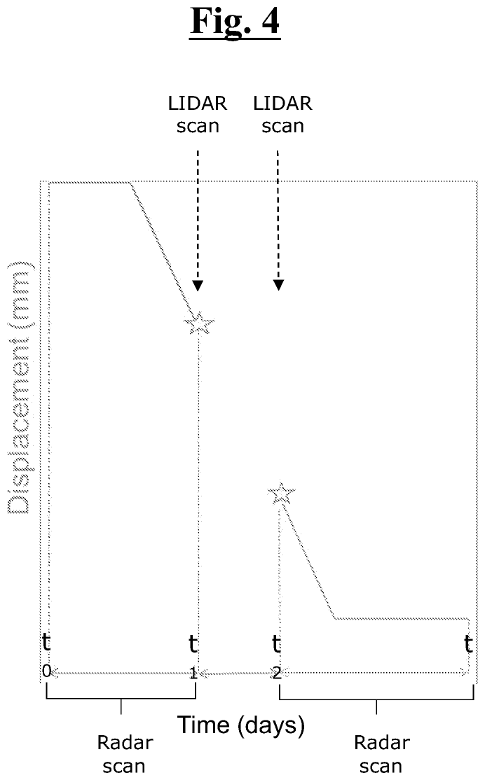

With reference to FIG. 4, in a possible embodiment of the method according to the present invention, a discontinuous monitoring procedure is also provided that allows, if necessary, to remove the device 100 from the monitoring point and subsequently to reposition it, then correcting or mitigating the repositioning errors that this action causes.

The procedure provides a first step of arranging device 100 at a monitoring point. In this monitoring point, the step of laser scanning of the scenario is carried out at instant t₁/obtaining a three-dimensional model comprising a plurality of points Pₗ, each point Pₗ having spatial coordinates Cₗ(t₁), and the step radar scanning of the scenario is carried at instant t₁, obtaining at least one matrix of complex data comprising information of amplitude and phase of a plurality of points Pᵣ, each point Pᵣ having spatial coordinates Cᵣ(t₁).

The device 100 is then removed and then repositioned at the monitoring point, resulting in a translation repositioning error Δrₚₒₛ≥0 and a rotation repositioning error Δφₚₒₛ≥0.

Again, the step of laser scanning at instant t₂, obtaining a three-dimensional model comprising a plurality of points Pₗ, each point Pₗ having spatial coordinates Cₗ(t₂), and the step of radar scanning at instant t₂, obtaining at least one matrix of complex data comprising information of amplitude and phase of a plurality of points Pᵣ, each point Pᵣ having spatial coordinates Cᵣ(t₂), are performed.

Subsequently, a comparison is made between the coordinates Cₗ(t₁) and Cₗ(t₂) of the points Pₗ obtaining the repositioning errors Δrₚₒₛ and Δφₚₒₛ and, therefore, a calculation of the relative interferogram is made comparing the matrix of complex data relative to the instant t₁ and the matrix of complex data relative to the instant t₂, taking into account the repositioning errors Δrₚₒₛ and Δφₚₒₛ.

The foregoing description embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. A method for monitoring the deformation of a scenario comprising the steps of:
prearranging a device (100) for monitoring the deformation of a scenario comprising:
a support (105);
a LIDAR sensor (110);
a radar sensor (120);
at least one actuator arranged to move said LIDAR sensor (110) and said radar sensor (120) with respect to said support (105);
defining a spatial reference system S comprising a rotation axis z, said spatial reference system S being integral with said support (105);
rotating said LIDAR sensor (110) about said rotation axis z, by means of said or each actuator;
during said step of rotating said LIDAR sensor (110), laser scanning of said scenario, obtaining a three-dimensional model comprising a plurality of points Pₗ of said scenario, for each point Pₗ of said scenario being known the spatial coordinates with respect to said spatial reference system S;
rotating said radar sensor (120) about said rotation axis z, by means of said or each actuator;
during said step of rotating said radar sensor (120), radar scanning of said scenario, obtaining at least two matrices of complex data comprising information of amplitude and phase of a plurality of points Pᵣ of said scenario, for each point Pᵣ of said scenario being known the spatial coordinates with respect to said spatial reference system S;
focusing said at least two matrices of complex data obtaining at least two focused images of said scenario;
comparing said at least two focused images of said scenario obtaining a relative interferogram;
generating a three-dimensional map of said scenario superimposing said relative interferogram with said three-dimensional model in such a way that points Pₗ and Pᵣ having the same spatial coordinates with respect to said spatial reference system S are superimposed to each other.

2. The method for monitoring the deformation of a scenario, according to claim 1, wherein said radar sensor is arranged to perform a scanning by means of SAR technology.

3. The method for monitoring the deformation of a scenario, according to claim 1, wherein said step of rotating said LIDAR sensor (110) and said step of rotating said radar sensor (120) take place simultaneously.

4. The method for monitoring the deformation of a scenario, according to claim 1, wherein a step is also provided of rotating said LIDAR sensor (110) about a rotation axis x, orthogonal to said rotation axis z, by means of said or each actuator, said step of rotating said LIDAR sensor (110) about said rotation axis x occurring simultaneously with said step of rotating said LIDAR sensor (110) about said rotation axis z.

5. The method for monitoring the deformation of a scenario, according to claim 1, wherein said LIDAR sensor (110) is arranged to simultaneously emit a plurality of laser beams at different elevation angles.

6. The method for monitoring the deformation of a scenario, according to claim 1, wherein said device (100) further comprises a camera (130) and wherein a step is also provided of acquiring photographic images of said scenario.

7. The method for monitoring the deformation of a scenario, according to claim 6, wherein a step is also provided of overlapping at least one of said photographic images with said three-dimensional model acquired by means of laser scanning.

8. The method for monitoring the deformation of a scenario, according to claim 1, wherein a step is also provided of generating a three-dimensional mesh starting from said three-dimensional model, said three-dimensional mesh comprising a plurality of faces arranged to define the shape of a polyhedral object of said scenario.

9. The method for monitoring the deformation of a scenario, according to claim 1, wherein a step is also provided of calculating at least one three-dimensional vector of displacement \vec{d} of the points of said scenario, said step of calculating comprising the steps of:
making at least two radar scans at a time interval Δtᵣ;
calculating a displacement value d_{LOS} representing the component along the line of sight of the displacement of a point Pᵣ between said two radar scans in said time interval Δtᵣ;
making at least two laser scans at a time interval Δtₗ;
calculating the vector of the displacement direction \vec{d}ₗₐₛₑᵣ of a point Pₗ having same spatial coordinates of said point Pᵣ, between said two laser scans in said time interval Δty, said vector of the displacement direction \vec{d}ₗₐₛₑᵣ having versor of displacement \hat{d}ₗₐₛₑᵣ and module dₗₐₛₑᵣ;
calculating the angle θ between said displacement direction calculated and said line of sight;
calculating said three-dimensional vector of displacement according to the equation \vec{d}=(d_{LOS}/cos θ)\hat{d}ₗₐₛₑᵣ.

10. The method for monitoring the deformation of a scenario, according to claim 9, wherein a step is provided of graphic superimposition of said or each vector of displacement d to said three-dimensional map of said scenario.

11. The method for monitoring the deformation of a scenario, according to claim 1, wherein a discontinuous monitoring procedure is provided comprising the steps of:
arranging said device (100) at a monitoring point;
making said step of laser scanning of said scenario at instant t₁, obtaining a three-dimensional model comprising a plurality of points Pₗ, each point Pₗ having spatial coordinates Cₗ(t₁);
making said step of radar scanning of said scenario at instant t₁, obtaining at least one matrix of complex data comprising information of amplitude and phase of a plurality of points Pᵣ, each point Pᵣ having spatial coordinates Cᵣ(t₁);
removing said device (100) from said monitoring point;
rearranging said device (100) in said monitoring point, resulting in a translation repositioning error Δrₚₒₛ≥0 and a rotation repositioning error Δφₚₒₛ≥0;
making said step of laser scanning of said scenario at instant t₂, obtaining a three-dimensional model comprising a plurality of points Pₗ, each point Pₗ having spatial coordinates Cₗ(t₂);
making said step of radar scanning of said scenario at instant t₂, obtaining at least one matrix of complex data comprising information of amplitude and phase of a plurality of points Pᵣ, each point Pᵣ having spatial coordinates Cᵣ(t₂);
comparing said coordinates Cₗ(t₁) and Cₗ(t₂) of said points Pₗ obtaining said repositioning errors Δrₚₒₛ and Δφₚₒₛ;
calculating the relative interferogram comparing said matrix of complex data relative to the instant t₁ and said matrix of complex data relative to the instant t₂, taking into account said repositioning errors Δrₚₒₛ and Δφₚₒₛ.

12. The method for monitoring the deformation of a scenario, according to claim 9, wherein, in the case of the condition d_{LOS(laser)}>λ/4, where d_{LOS(laser)}=\vec{d}ₗₐₛₑᵣ*cos θ and λ is the wavelength of said radar sensor, a step is provided of disambiguating the radar measurement wherein said displacement value d_{LOS} is replaced by a modified displacement value
$${{d}_{LOS}}^{′} = {d}_{LOS} + \frac{λ}{2} {k}_{laser ′} {k}_{laser} = - floor [ \frac{- 2 {d}_{LOS ( laser )}}{λ} + \frac{1}{2} ] .$$

13. The method for monitoring the deformation of a scenario, according to claim 1, wherein in case that, following said laser scanning of said scenario, there is ambiguity in calculating a spatial coordinate Rₗ of a point Pₗ, obtaining possible spatial coordinates Rₗ₍ᵢ₎, with i=1, 2, . . . , n, a step is provided of disambiguating the laser measurement, wherein it is identified the spatial coordinate Rᵣ of a point Pᵣ obtained by means of radar scanning and having spatial coordinates, except Rᵣ, closest to the coordinates of Pₗ, in order to select the coordinate closest to Rᵣ among said possible spatial coordinates Rₗ₍ᵢ₎.

14. A device (100) for monitoring the deformation of a scenario comprising:
a support (105);
a LIDAR sensor (110);
a radar sensor (120);
at least one actuator arranged to move said LIDAR sensor (110) and said radar sensor (120) with respect to said support (105);
said device (100) also comprising a control unit arranged to:
defining a spatial reference system S comprising a rotation axis z, said spatial reference system S being integral with said support (105);
operating a rotation of said LIDAR sensor (110) about said rotation axis z, by means of said or each actuator;
during said step of rotating said LIDAR sensor (110), operating a laser scanning of said scenario, obtaining a three-dimensional model comprising a plurality of points Pₗ of said scenario, for each point Pₗ of said scenario being known the spatial coordinates with respect to said spatial reference system S;
operating a rotation of said radar sensor (120) about said rotation axis z, by means of said or each actuator;
during said step of rotating said radar sensor (120), operating a radar scanning of said scenario, obtaining at least two matrices of complex data comprising information of amplitude and phase of a plurality of points Pᵣ of said scenario, for each point Pᵣ of said scenario being known the spatial coordinates with respect to said spatial reference system S;
carrying out a focusing of said at least two matrices of complex data obtaining at least two focused images of said scenario;
carrying out a comparison of said at least two focused images of said scenario obtaining a relative interferogram;
generating a three-dimensional map of said scenario by superimposing said relative interferogram with said three-dimensional model in such a way that points Pₗ and Pᵣ having the same spatial coordinates with respect to said spatial reference system S are superimposed to each other.

15. The device (100) for monitoring the deformation of a scenario, according to claim 14, wherein a camera (130) is also provided and wherein said control unit is arranged to operate an acquisition of photographic images of said scenario.
